(19) United States
(12) Patent Application Publication
(10) Pub. No.: US 2008/0086340 A1
(43) Pub. Date: Apr. 10, 2008

(54) CROP QUALITY INSURANCE

(75) Inventors: JOSEPH P. FORESMAN, Clive, IA (US); DOUGLAS M. HAEFELE, Johnston, IA (US); J. KENT WANAMAKER, Des Moines, IA (US); ANDREW G. GOODMAN, Grimes, IA (US); DAVID M. SEVENICH, Johnston, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignees: PIONEER HI-BRED INTERNATIONAL, INC., Johnston, IA (US); E.I. DU PONT DE NEMOURS AND COMPANY, Wilmington, DE (US)

(21) Appl. No.: 11/866,468

(22) Filed: Oct. 3, 2007

Related U.S. Application Data
(60) Provisional application No. 60/828,079, filed on Oct. 4, 2006.

(51) Int. Cl. G06Q 40/00; G06Q 50/00; G06Q 90/00

(52) U.S. Cl. 705/4

(57) ABSTRACT

A method for providing insurance includes providing a bundle of products and services to a crop producer, the bundle of products and services comprising seed products and insurance. The insurance provides a benefit to the crop producer if grain grown from the seed products does not meet or exceed a crop quality threshold. The method further includes determining if crop grown from the seed products meets or exceeds the crop quality threshold and if the crop does not meet or exceed the crop quality threshold, providing the benefit to the crop producer according to the insurance. The benefit may be a cash benefit or a seed credit. The crop quality may be related to a particular end use for the grain such as ethanol production, food production, or use as a livestock feed.

### CROSS-REFERENCE TO RELATED APPLICATIONS

This application claims priority to provisional application Ser. No. 60/828,079 filed Oct. 4, 2006, herein incorporated by reference in its entirety.

### BACKGROUND OF THE INVENTION

The present invention relates to crop quality. In particular, the present invention relates to providing insurance for crop quality.

Harvested crops, such as grain or cellulose materials are not necessarily completely fungible commodities. In particular, it is known that some grain or cellulose material may be of higher value for particular end uses than other grain or cellulose material. The quality of the crop is based in part on the genetics of the crop. Higher quality crops create increased value.

Crop quality may be measured differently and of differing importance depending upon the particular end use, including uses such as but not limited to livestock feed, ethanol production, and food production. One use where crop quality can be of particular importance is in ethanol production. Ethanol is generally blended with gasoline at various levels to fuel motor vehicles. Due to limited supplies of crude oil and limitations in refining capacity, concerns over environmental degradation, and the resulting increase in gasoline prices, there appears to be a good outlook for further growth in the ethanol market. Ethanol can be produced from various sources, including grains such as corn, barley, and wheat, as well as cellulose feedstocks.

In ethanol production, higher quality crops result in improved efficiency in that less crop of a higher quality is needed to produce a particular amount of ethanol than would be required if the crop was of an average quality. Thus, receiving higher quality creates higher value for an ethanol producer. Ethanol production is merely one example where higher quality crops create value for a processor.

What is needed is a method which identifies and addresses the value created by higher quality crops, provides incentives to producers to use seed products having the appropriate genetics to yield higher quality crops, and allocates the value of higher quality crops to stakeholders while minimizing risks for producers.

### BRIEF SUMMARY OF THE INVENTION

According to one aspect of the present invention, a method for providing insurance includes providing a bundle of products and services to a crop producer, the bundle of products and services comprising seed products and insurance. The insurance provides a benefit to the crop producer if the crop grown from the seed products does not meet or exceed a crop quality threshold. The method further includes determining if the crop grown from the seed products meet or exceed the crop quality threshold. If the seed products do not meet or exceed the crop quality threshold, the method provides the benefit to the crop producer according to the insurance.

### BRIEF DESCRIPTION OF THE DRAWINGS

FIG. 1 illustrates one example of a methodology of the present invention.

FIG. 2 is a block diagram illustrating relationships between grain quality insurance an input supplier, a producer, and a processor.

FIG. 3 is a block diagram illustrating examples of possible requirements for grain quality insurance.

FIG. 4 illustrates one method specific to the end use of the grain in ethanol production.

FIG. 5 illustrates one method where grain quality insurance is used to compensate for grain which is discounted because its quality is not above a threshold.

FIG. 6 is a block diagram illustrating decision-making.

FIG. 7 is a block diagram illustrating components of crop quality insurance underwriting.

FIG. 8 illustrates one method for crop quality insurance.

FIG. 9 illustrates another method for crop quality insurance.

### DETAILED DESCRIPTION OF THE PREFERRED EMBODIMENT

Methods and systems for creating or capturing value for crop producers, processors, and/or input suppliers are provided. The methods may provide an incentive to a producer for using a particular type of seed product. The methods may assist a producer in insuring against loss if a seed product does not grow a crop that meets a particular quality threshold. The methods may provide an opportunity to the producer to capture premiums for crops as well as to increase a processor's access to crops meeting a desired quality threshold. In addition, the methods provide an opportunity for a seed supplier to convey to customers the quality of their seed products, including for particular end uses. In addition, the methods allow for bundling of crop production inputs with insurance.

It should be appreciated that there are numerous types of crops and measures of quality for the crops. Crops can may be silage and forage type crops, grain crops, or other types of crops. Often times throughout this specification reference is made to corn or other grains and sometimes the term “grain quality” is used to refer to the quality of grain. Such disclosure is merely representative and it is to be understood that grain is merely one type of crop product.

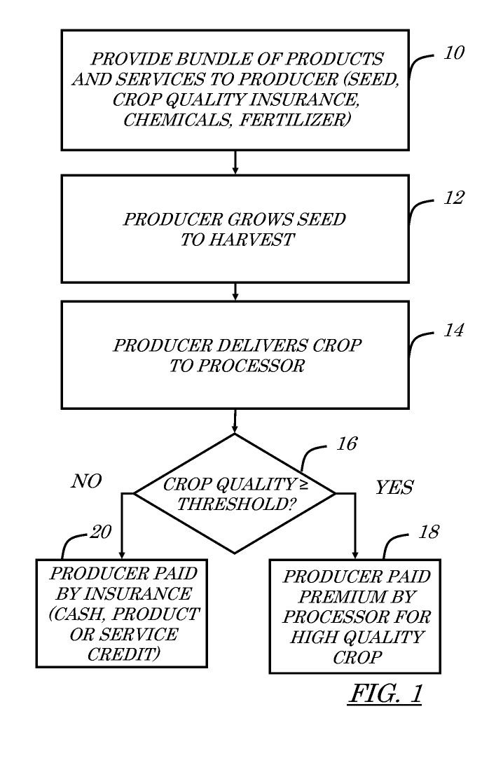

FIG. 1 provides an overview of one method. In FIG. 1, step 10, a bundle of products and services is provided to a producer. The bundle of products and services includes agricultural inputs including seed, crop quality insurance. Other types of agricultural inputs may be provided as a part of the bundle. These may include traditional agricultural inputs such as chemicals and fertilizers, as well other products or services that assist a producer in crop production.

Next, in step 12, a producer grows the seed to harvest. After which, the producer delivers harvested crop to a processor in step 14. In step 16, the processor evaluates the delivered crop to determine if the grain quality meets or exceeds a desired threshold. Examples of quality-related traits for field crops include traits related to ethanol yield, traits related to predicted digestible energy levels, protein content, starch content, extractable starch content, oil content, and extractable oil content. Quality-related traits may include whether or not the crop is of a variety having a particular gene or set of genes. Quality-related traits may be based on amino acid content, fiber content, enzyme content, fatty acid content, oil profile, or other types of content or composition. Quality-related traits may relate to the desired end use. For example, where the crop is used for feed, quality-related traits may include nutrient content, amino acid content, and more specifically, amino acid content of one or more essential dietary amino acids such as arginine, histidine, isoleucine, lysine, methionine, phenylalanine, threonine, tryptophan, and valine.

Any number of means can be used to measure its composition or other quality-related traits. Knowledge of quality leads to an understanding of the inherent value of the crop to the processor or other user of the crop. The inherent value of the crop to the processor may vary according to the specific processes used by the processor. Because of the varying value of grain to a processor, the processor is willing to pay the producer differentially based on crop quality.

For example in ethanol processing, where grain to be harvested is known to have a particularly high potential ethanol yield, an ethanol processor will know that less grain will be required which creates significant value for the ethanol processor. Of course, various types of processing operations may be performed by a processor. The processor may provide for ethanol processing, sugars processing, starch processing, beverage alcohol processing, or snack/cereal processing. In different types of processing, different characteristics for the crop may be at a premium. The processing may result in products used in food manufacturing. Of course, little processing may be required such as where the crop is used for feed in livestock production. A livestock feeder is considered to be a processor for purposes of this application.

Depending upon the particular use for the crop, quality may be measured in different ways. Where the quality-related trait is not directly measured, predictive models may be used as is known in the art. Quality-related traits which may be determined by predictive models include, without limitation, high extractable starch (HES), high total fermentables (HTF), high available energy (HAE), amino acid content, and enzymatic content. Other examples of quality-related traits for the production of dry-grind ethanol include high total fermentables, low stress cracks, and low occurrence of molds and diseases. Total fermentables is the sum of all starches and simple sugars that ferment in the typical dry-grind process.

It should further be understood that grain quality may also be based at least in part on genetic traits, including genetic traits that are not just simple generation traits, such as starch genotype. Genetic traits such as herbicide resistant traits or insect resistant traits may be used in determining crop quality. Examples of herbicide resistant traits include, without limitation, glyphosate resistance traits, sulfonylurea (SU) resistance traits, dicamba resistance traits, imidazolinone resistance traits, LIBERTYLINK traits, and other types of herbicide resistant traits. Examples of insect resistance traits include, without limitation, corn borer resistance traits, HERCULEX traits, and other types of traits which may be used in determining crop quality.

Other types of crop quality traits include grain footprint, variations in native enzymes, kernel shape and density, test weight, hardness of endosperm, and other characteristics indicative of quality. With respect to soybeans, crop quality may include, without limitation, oil content, oil profile, fatty acid profile, polyunsaturated fatty acid content, omega-3 content, amino acid profile, flavor, protein content, and whether the grain quality is of food grade or not. With respect to corn forage, examples of crop quality traits may include, without limitation, dry matter content, starch content, protein content, crude protein content, ash content, whole plant (WP) moisture, whole plant (WP) digestibility, NDF digestibility, starch digestibility, and sugars content. With respect to corn silage, examples of crop quality traits may include, without limitation, dry matter content, starch content, protein content, ash content, oil content, lactic acid content, acetic acid content, propionic content, pH level, nitrogen content, acid detergent fiber (ADF) content, neutral detergent fiber (NDF) content, NDF digestibility, crude fiber content, mold or toxin presence, and volatile fatty acid profile. The examples of types of crops and types of crop quality related traits are merely representative.

One way of measuring traits is through the use of a near-infrared analyzer. Near-infrared analyzers may be used to indicate grain types or grain constituents as well as other indicators of crop quality. Examples of crops where near-infrared analyzer measurements may assist in determining crop quality include, without limitation, alfalfa, legume hay, grass hay, mixed grass and alfalfa hay, small grain hay, straw, millet hay, sorghum hay, alfalfa haylage, grass haylage, alfalfa and grass mixed haylage, corn silage, sorghum silage, small grain silage, shelled corn, ear corn, high moisture corn, earlage, and soybeans.

The present invention contemplates that crop quality can be measured using other types of technologies. For example, grain quality can be determined through imaging the grain and applying appropriate image processing techniques to the image to extract information about the grain.

Another type of technology that can be used for measuring grain quality is the ACURUM system available from DuPont Acurum. The ACURUM system is based on a visual measurement (CCD camera operating in the visible spectral region). This system has currently been used for wheat and barley. Examples of grain quality traits include wheat contamination in barley, fungi in wheat, and staining in wheat. Of course, other types of grain quality measurements are contemplated. There are numerous technologies which may yield measures of grain quality such as, but not limited to gas chromatography, acoustical technologies, imaging techniques, and combinations of techniques. The imaging techniques may also include those associated with remote sensing.

These and other technologies can determine numerous types of grain quality traits. For example, NIR or a combination of NIR and UV-visible spectroscopy can report for whole grain and include oil, protein, total starch, extractable starch, fermentability, individual fatty acid levels, and animal feed value in corn. Of course, different types of grains will have different grain quality measurements of interest. In addition, the grain quality measurements of interest may vary depending on the particular end use of the grain, or other factors. Other types of technologies include x-ray diffraction as well as other types of electromagnetic technologies.

Examples of other technologies that can be used for determining crop quality include automated methods of measuring enzymes such as through scalar flow-injection analysis equipment or other types of automated methods or assays.

The crop quality measurements are preferably performed at harvest or delivery. The crop quality measurements may be taken using remote sensing techniques and an aerial view of a field prior to harvest. The crop quality measurements may be taken using an appropriately equipped combine or other grain harvesting machine. The grain quality measurements may be taken at any appropriate auger or chute used in the grain handling process associated with harvesting or delivery. As previously explained, the grain quality measurements may also be taken prior to harvest, or can also be taken after delivery. Various types of methods may be used to increase the likelihood that consistent crop quality determinations are made. This can include following of procedures for the calibration of crop quality determination equipment, sampling of crops for additional or independent testing, or other procedures.

If the quality of the crop meets or exceeds the threshold, then in step 18, the producer is paid for the grain by the processor. The payment includes a premium because the grain meets or exceeds the threshold. The premium may also be considered a non-discounted price depending on the pricing structure for the crop. Returning to step 16, if it is determined that the crop quality does not meet the threshold, then in step 20 the producer is compensated through the terms of the crop quality insurance. The compensation may be a direct cash payment. Alternatively, the payment may be credit for future products or services. For example, the credit may be a seed credit to be used for purchases of seed in the future.

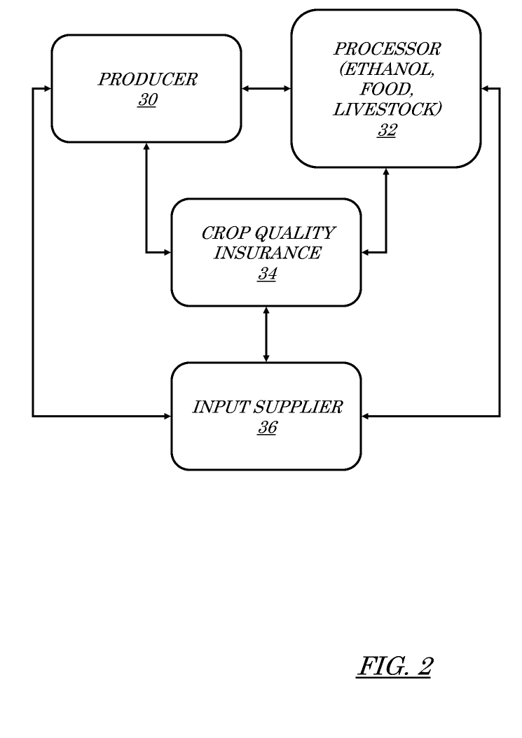

FIG. 2 is a block diagram illustrating relationships between grain quality insurance and an input supplier, a producer, and a processor. As shown in FIG. 2, the producer 30, processor 32, and input supplier 36 all may have a role in an offering of crop quality insurance. As shown in FIG. 2, the producer 30 has a relationship with the processor 32 as well as the input supplier 36. The input supplier 36 also has a relationship with the producer 30 as well as the processor 32. The crop quality insurance 34 is related to the producer 30, the processor 32, and the input supplier 36. Because the crop quality insurance 34 is related to the producer 30, the processor, 32, and the input supplier 36, it is to be understood that one or more of a producer, a processor, and an input supplier may pay the premium for a crop insurance program, and that the benefit may be paid to one or more of a producer, a processor, and an input supplier. Numerous ways of structuring a crop quality insurance program are contemplated.

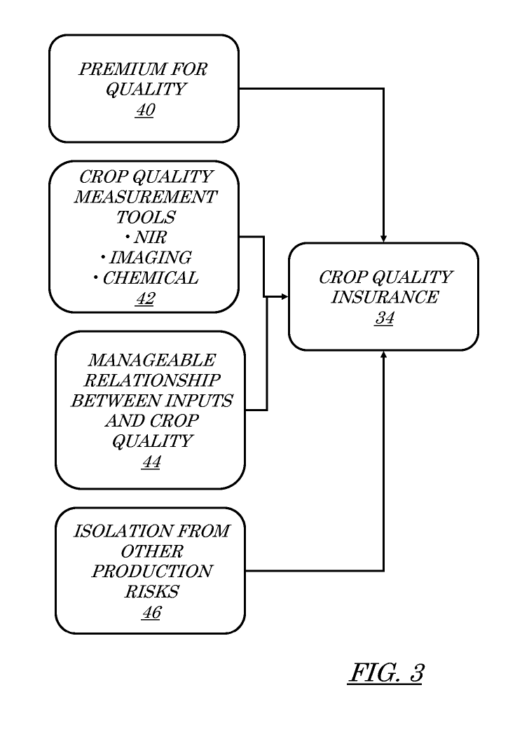

FIG. 3 is a block diagram illustrating preferred requirements for grain quality insurance according to one embodiment of the present invention. The grain quality insurance 34 preferably relies upon a premium for quality 40. The premium for quality 40 may be greater for some end uses than other end uses. For example, the premium for quality 40 may be greater for ethanol production processes where there are greater time or cost savings for the processing of higher quality grain as opposed to inferior quality grain. The grain quality insurance 34 also uses some type of grain quality measurement tools 42. One preferred type of grain quality measurement tools are those using NIR. Such tools allow for rapid measurement. Of course, other types of tools may be used. The types of tools used depend upon the particular types of characteristics used to determine grain quality. The grain quality insurance 34 also preferably uses a manageable relationship between inputs and grain quality 44. For example, knowledge of seed products and which seed products will, under expected growing conditions result in grain of the desired quality is important. Thus, for example, a seed company is particular well-suited for knowing the genetics of its products and whether the genetics of its products are of sufficient quality to underwrite the grain quality insurance. Another example of a useful relationship for successfully offering grain quality insurance is the ability to isolate the risk of grain not being of sufficient quality from other production risks. Even where seed products or other agricultural inputs are of sufficient quality to yield high quality grain, unexpected production practices, unexpected environmental risks such as adverse weather conditions, pest infestation, or other risks may result in crop failure. The present invention contemplates various ways in which these risks can be isolated. One way in which such risks can be isolated is through requiring a producer to be separately insured with multi-peril crop insurance, crop revenue insurance, or other types of traditional crop insurance products. Another way in which such risks can be isolated and managed is through requiring the producer to disclose their expected production practices and to require the producer to follow-through with such production practices, or other prescribed production practices.

Various crops and various end uses may be used. One example of a crop and its end use is the use of corn for ethanol production, and generally dry-mill ethanol production. Of course, various other end uses, including food uses, livestock use, and others are contemplated. In addition, other grains may be used.

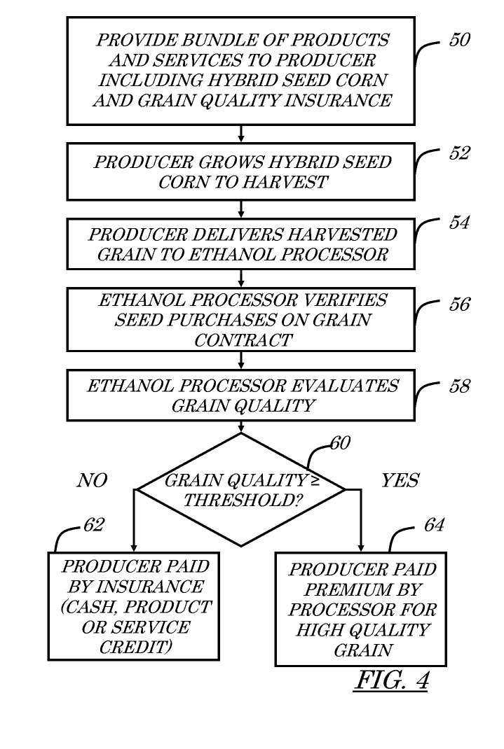

FIG. 4 illustrates one method in the context where the agricultural input being supplied at least includes seed products and where the processor of the grain is an ethanol processor. In step 50, a seed supplier, such as a seed company working independently or in conjunction with other agricultural input suppliers provides a bundle of products and services to a grain producer. The bundle includes at least hybrid seed corn and grain quality insurance. The insurance covers a fraction of the ethanol premium paid by the ethanol processor. The insurance is brought for the benefit of the grower to protect the grower up to the fraction of the premium insured by the seed supplier in exchange for planting seeds supplied by the seed supplier.

Next, in step 52, the producer grows the hybrid seed corn to harvest. In step 54, the grain producer delivers the harvested grain to an ethanol processor. In step 56, the ethanol processor verifies seed purchases on the grain contract. This step of verification can be used to verify that the grain being delivered was produced from the hybrid seed corn which formed a part of the bundle in step 50. Other types of information that the ethanol processor may verify include quantity, type of hybrid, acreage estimate, or other information. Such information is of independent value to the processor in that such information assists the processor in their analysis of which seed products result in the highest quality grain, and for which seed products they would be willing to contract for in future years. Next, in step 58, the ethanol processor evaluates grain quality, preferably high total fermentables, and/or other grain quality attributes which relate to the value of the grain to the ethanol processor. The present invention contemplates that grain quality can be valuated in numerous ways, and need not be evaluate based upon a single physical quality. Instead, an overall grain quality may be based on a combination of quality factors as may be appropriate for a particular ethanol processor and their specific ethanol production process.

Next, in step 60, grain quality is compared to a grain quality threshold value. If the grain quality exceeds the threshold, then in step 64, the producer is paid by the ethanol processor for the high quality grain. If in step 60, the grain quality does not exceed the grain quality threshold, then in step 62, the producer is paid based upon the terms of the insurance provided in step 50. The terms of the insurance may provide for the producer to receive a fraction of the ethanol premium which has been insured. The financial benefit of higher quality grain to an ethanol processor may vary. For example, grain having HTF may provide a dry grind ethanol processor a significant benefit. The benefit provided may be a 2-5 percent benefit, a 5-10 percent benefit or even an 8-12 percent benefit. The benefit is increased, for example, when the total starch increases and the availability of starch for hydrolysis increases. Depending upon the ethanol price, this may be, for example, a 5 to 30 cent per bushel of corn advantage. Thus, this is a significant advantage.

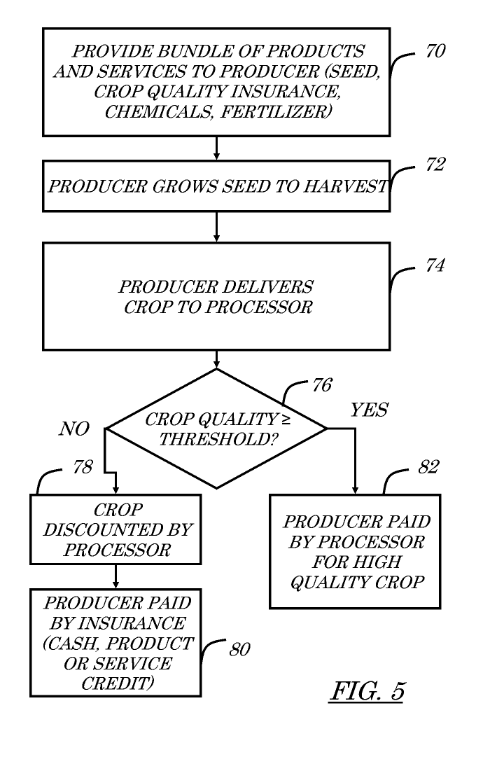

FIG. 5 illustrates another methodology. FIG. 5 is similar to the method shown in FIG. 1 except that instead of a producer being rewarded with a premium by a processor for higher quality crop, the crop value is discounted by the processor where crop quality is not as high as demanded by the processor. In step 70, a bundle of products and services is provided to a producer. The bundle of products and services includes agricultural inputs including seed and crop quality insurance. Other types of agricultural inputs may be provided as a part of the bundle. These may include traditional agricultural inputs such as chemicals and fertilizers, as well other products or services that assist a producer in crop production.

Next, in step 72, a producer grows the seed to harvest. After which, the producer delivers harvested crop to a processor in step 74. In step 76, the processor evaluates the delivered crop to determine if the crop quality meets or exceeds a desired threshold. If the crop quality does meet the threshold requirement, then in step 78, the producer's crop is discounted by the processor. In step 80, however, because the crop quality was lower than the threshold requirement, the crop quality insurance provides a payment to the producer in the form of cash, a product or service credit, or otherwise. The payment may be the same or less than the amount that the crop of the producer was discounted depending on the terms of the crop quality insurance. Returning to step 76, if the crop quality meets or exceeds the threshold requirement, then in step 82, the processor pays the producer for the high quality crop.

In order to participate in such a program, the present invention contemplates that additional requirements may be made. For example, such a program may only be eligible for seed customers of the supplier. The producers may be required to carry other types of crop insurance, use particular management practices, use seed product recommendations from the seed supplier, engage in only approved crop production management practices, or other requirements that reduce production risks.

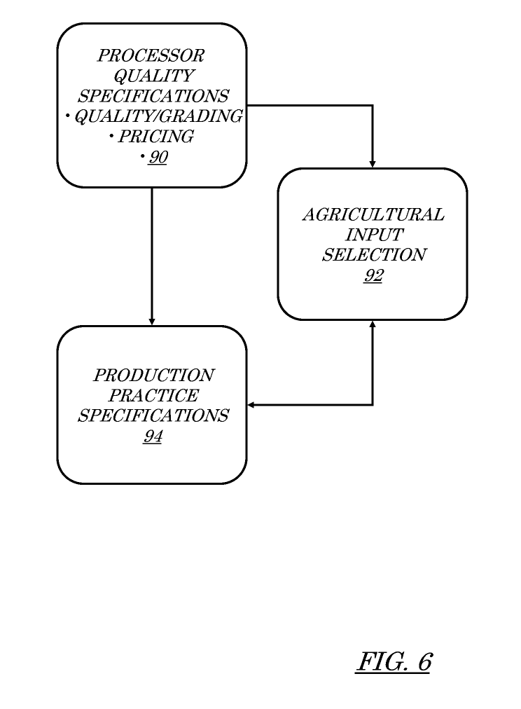

FIG. 6 illustrates one way to implement a crop quality insurance program. In step 90, a processor provides a quality specification 90. The processor quality specification 90 details the desired crop quality and how the crop quality is determined. There may be a single minimum threshold for crop quality. Alternatively, there may be various grades of crop quality. Crop quality may be based on a single crop quality characteristic or a combination of crop quality characteristics. The crop quality specification may also provide pricing information regarding the premium or discount applied to crop of different qualities. This pricing information may be absolute or may be relative, such as a percentage of the market price at the time of delivery.

Based on the processor quality specification 90, agricultural input selections 92 and production practice specifications 94 are determined. It is to be understood that agricultural input selections 92 and production practice specifications 94 may be inter-related. An agricultural input supplier may make the determinations of the agricultural input selections 92 and the production practice specifications 94 based on the processor quality requirements 90 as well as an understanding of interactions between one or more agricultural inputs, production practices, other relevant information including producer-specific information and information regarding the agricultural input supplier's products and services. Based on the information regarding the processor quality specification 90, the agricultural input selection 92, production practice specification 94, a crop quality insurance policy may be underwritten.

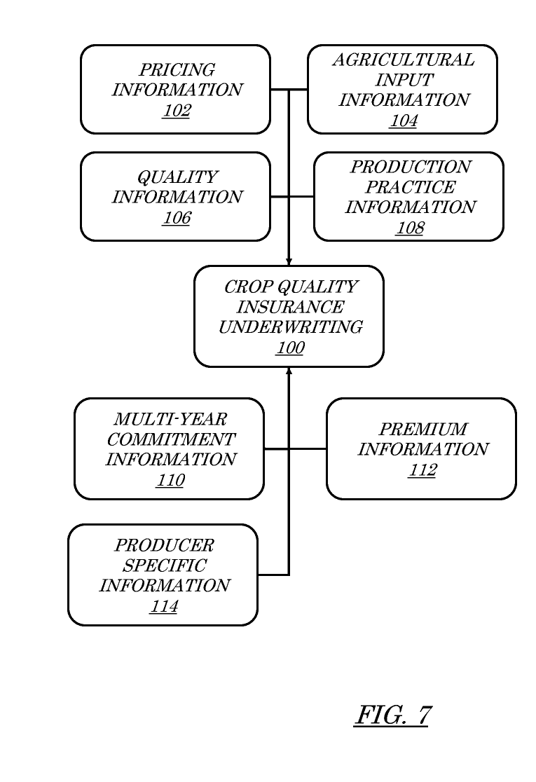

FIG. 7 provides additional details regarding the underwriting. In the underwriting a determination is made as to how much risk is associated with a crop quality insurance policy. In the underwriting process a determination is also made in terms of how much coverage is available, and other factors. Examples of information that can be used in the underwriting process to assess or estimate risk associated with crop quality insurance underwriting 100 include pricing information 102, agricultural input information 104, quality information 106, and production practice information 108. Other information may include multi-year commitment information 110, premium information 112, and producer specific information 114. Of course, additional information may also be used to assist in the underwriting process.

The multi-year commitment information 110 contemplates that a producer may be asked to commit to a crop quality insurance program over multiple years. Having a multiple year program may reduce risk or at least spread the risk out over multiple years. A multi-year program also may also help in adapting the agricultural inputs and production practice information to a particular producer's land base to better manage production risks involved. A multi-year commitment requirement may be required to be made by producers to participate in this program. Under such an agreement, in order to receive the guaranteed minimum premium on every bushel delivered to the processor, the producer must agree to purchase the same amount or more seed from the seed supplier for a given time period.

As previously discussed, the indemnity may be paid in seed credits for the next year rather than in cash. In such an arrangement, the seed supplier need not pay cash to the producer, yet the producer still receives a significant benefit. Such an arrangement provides incentive for the producer to purchase seed products from the seed supplier in the future. Where such a crop quality insurance program requires a multi-year commitment, the seed credit may apply only to the purchase of seed products outside of the program.

The premium information 112 may include information regarding how much it costs to receive the benefit of crop quality insurance. The cost of the insurance may be funded by an agricultural input supplier, such as, but not limited to a seed supplier. Or alternatively, the agricultural input supplier may fund a portion of the premium with the producer funding the rest of the premium. The processor may also fund a portion of the premium. An agricultural input supplier, such as seed supplier may be willing to pay all or a portion of the premium in order to communicate to producers their confidence in their agricultural products and the agricultural input supplier may build the premium into the price for their products or services. A processor may be willing to pay a portion of the premium as one tool for managing their supply of high quality crops.

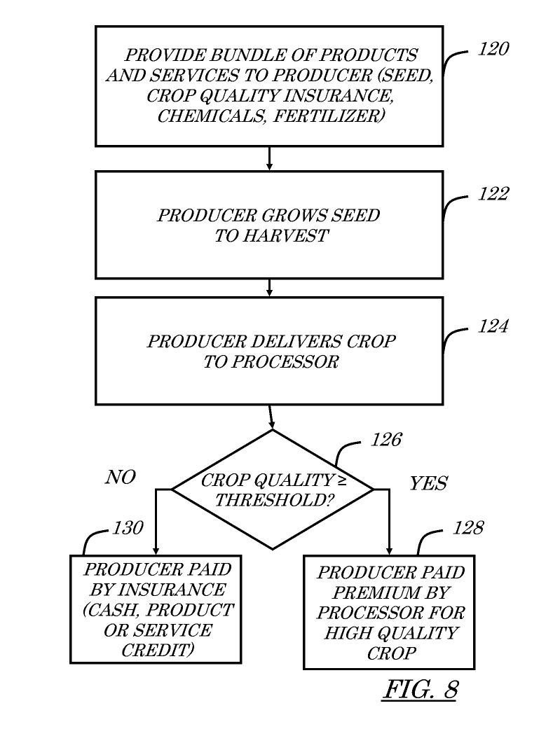

FIG. 8 illustrates another method. In step 120, a bundle of products and services is provided to a producer. The bundle may include, without limitation, seed, crop quality insurance, chemicals, fertilizers and other inputs. Next, in step 122, the producer grows the seed to harvest. In step 124, the producer delivers the resulting crop to a processor. The crop may be grain or other plant material. In step 126, a determination is made as to whether the crop quality meets or exceeds a crop quality threshold. If it does, then in step 128, the producer is paid a premium price, or at least an undiscounted price for the high quality crop. If the crop quality does not meet the crop quality threshold in step 126, then in step 130, the producer is paid by insurance. The producer may be paid using cash or a product or service credit.

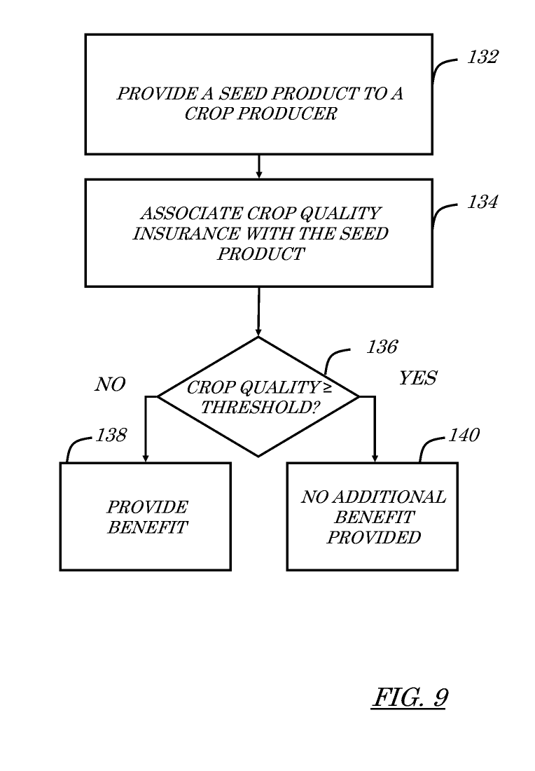

FIG. 9 illustrates another method. In step 132 a seed product is provided to a crop producer. In step 134 crop quality insurance is associated with the seed product. In step 136, the quality of a crop grown from the seed product is compared to a threshold. If the crop quality meets or exceeds the threshold, then no additional benefit is provided. If the crop quality does meet or exceed the threshold then a benefit is provided in step 138.

It should be understood that the manner in which crop quality insurance is provided, the manner in which premiums are paid for, and the manner in which payment is made if adequate crop quality is not obtained can vary in numerous ways. Where there is a producer, one or more processors, and one or more agricultural input suppliers, all are stakeholders. For example, for the method shown in FIG. 9, it is to be understood that the benefit may be paid from an agricultural input supplier directly to the processor so that the producer receives a non-discounted price. Thus, it should be apparent that the benefit need not be paid directly to the producer by an agricultural input supplier. It should also be understood that the premium may be paid by the processor, the agricultural input supplier, the producer, or any combination thereof. For example, in areas where there is competition for high quality crops between different processors, the insurance program provides one way in which the processors can increase their competitiveness—by agreeing to provide a producer who meets certain conditions (such as use of particular agricultural inputs) the incentive of selling to the processor as the producer would receive a guaranteed premium for selling to the processor even if their crop did not meet the crop quality threshold. An agricultural input supplier may be pay for part or all of the premium because such an insurance program provides an incentive for using agricultural inputs which are requirements of the program.

Thus, methods for a crop quality insurance program have been described. It is to be understood that the present invention is not to be limited by the particular type of crop, the particular type of inputs of products and services being supplied, or the end use of the crop. Instead, the present invention is to be understood to encompass numerous variations as may be appropriate for a particular end use, a particular type of crop, or particular agricultural inputs.

What is claimed is:

1. A method for providing insurance, comprising:
providing a bundle of products and services to a crop producer, the bundle of products and services comprising seed products and insurance;
wherein the insurance provides a benefit to the crop producer if crop grown from the seed products does not meet or exceed a crop quality threshold;
determining if crop grown from the seed products meet or exceed the crop quality threshold;
if the crop grown from the seed products does not meet or exceed the crop quality threshold, providing the benefit to the crop producer according to the insurance.

2. The method of claim 1 wherein the crop quality threshold is from the set consisting of high total fermentables (HTF) threshold, a high available energy (HAE) threshold, and a high extractable starch (HES) threshold.

3. The method of claim 1 wherein the seed products are hybrid corn seed products.

4. The method of claim 1 wherein the quality threshold being related to a use for the crop.

5. The method of claim 1 wherein a purchaser of the crop pays a premium for crop meeting or exceeding the quality threshold.

6. The method of claim 1 wherein a purchaser of the crop pays a discounted price for crop not meeting the quality threshold.

7. The method of claim 1 wherein the step of determining being performed by a processor of the crop.

8. The method of claim 1 wherein the step of determining being performed at harvest.

9. The method of claim 1 wherein the step of determining being performed at delivery of the crop to the purchaser.

10. The method of claim 1 wherein the step of determining being performed using near infrared analytics.

11. The method of claim 1 wherein the step of determining being performed using image analysis.

12. The method of claim 1 wherein the benefit is a monetary value corresponding with at least a portion of premium paid for crop meeting or exceeding the quality threshold.

13. The method of claim 1 wherein the benefit being a seed credit for use in purchasing seed products.

14. The method of claim 1 wherein the bundle of products and services further comprises at least one input selected from the set consisting of fertilizers, pesticides, and crop services.

15. The method of claim 1 wherein the crop is from the set consisting of a grain, silage, a forage.

16. A method for providing insurance, comprising:
providing a bundle of products and services to a crop producer, the bundle of products and services comprising seed products and crop quality insurance;
wherein the insurance provides a benefit to the crop producer if crop grown from the seed products does not meet or exceed a crop quality threshold associated with ethanol production, the crop quality threshold at least partially based on high total fermentables;
determining if crop grown from the seed products meets or exceeds the crop quality threshold associated with ethanol production;
determining a premium for crop grown from the seed products which meets or exceeds the crop quality threshold associated with ethanol production;
if the seed products do not meet or exceed the crop quality threshold, providing the benefit to the crop producer according to terms of the crop quality insurance, the benefit at least partially based on the premium.

17. The method of claim 16 wherein the benefit being from the set consisting of a cash value and a seed credit.

18. The method of claim 16 wherein the step of determining if crop grown from the seed products meets or exceeds the crop quality threshold is performed using a near infrared analyzer.

19. The method of claim 16 wherein the step of determining if crop grown from the seed products meets or exceeds the crop quality threshold is performed using imaging.

20. A method of providing crop quality insurance, comprising:
providing a seed product to a crop producer;
associating crop quality insurance with the seed product;
receiving a determination of whether crop grown from the seed product meets or exceeds a crop quality threshold;
if the crop grown from the seed product does not meet or exceed the threshold providing a benefit under the crop quality insurance.

21. The method of claim 20 wherein the benefit is provided to a processor of the crop.

22. The method of claim 20 wherein the benefit is provided to the crop producer.

23. The method of claim 20 wherein the crop producer pays a premium for the crop quality insurance.

24. The method of claim 20 wherein a supplier of the seed product pays a premium for the crop quality insurance.

25. The method of claim 20 wherein a processor of the crop pays a premium for the crop quality insurance.
